(19) United States
(12) Patent Application Publication
(10) Pub. No.: US 2009/0315785 A1
(43) Pub. Date: Dec. 24, 2009

(54) ANTENNA AND WIRELESS COMMUNICATION DEVICE USING SAME

(75) Inventor: CHIH-YUAN YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/261,050

(22) Filed: Oct. 30, 2008

(30) Foreign Application Priority Data
Jun. 20, 2008 (CN) 200810302241.6

(51) Int. Cl. H01Q 1/24; H01Q 1/38

(52) U.S. Cl. 343/702; 343/700 MS

(57) ABSTRACT

An antenna includes a metallic sheet defining a first slot, a second slot, a third slot parallel to the first slot, and a fourth slot parallel to the second slot. The second slot perpendicularly connects the first slot to the third slot and has a length greater than that of the fourth slot. The third slot has a length greater than that of the first slot. The fourth slot extends perpendicularly from a side of the third slot away from the second slot. A feeding point is formed on the metallic sheet at a side of the fourth slot away from the third slot. A grounding point is formed on the metallic sheet at a side of the fourth slot away from the third slot at a position different from that of the feeding point.

### BACKGROUND

1. Technical Field

The present disclosure relates to an antenna and a wireless communication device using the same.

2. Description of the Related Art

Wireless communication devices use specifically designed antennas to transmit and receive compatible radio-frequency signals. Cell phones, for example, are designed with antennas that are used to handle radio-frequency communications with cellular base stations. Handheld computers often include short-range antennas for handling wireless connections with wireless access points. Global positioning system (GPS) devices typically contain antennas that are designed to operate at GPS frequencies.

To ensure normal operation of the antenna, a housing or part of the housing of a wireless communication device may be made of plastic. However, a device with a plastic housing is usually less popular than a device with a metallic housing since it is a trend to use metallic housings in the wireless communication devices, while maintaining normal operation of the antenna.

### BRIEF DESCRIPTION OF THE DRAWINGS

FIG. 1 is a schematic, isometric view of a wireless communication device according to a first exemplary embodiment.

FIG. 2 is a cut-way view of the wireless communication device of FIG. 1.

FIG. 3 is a schematic view of an antenna of the wireless communication device of FIG. 1.

FIG. 4 is similar to FIG. 3, but showing the size of the antenna.

FIG. 5 is a graph showing the return loss versus frequency characteristic of the antenna of FIG. 3.

FIG. 6 is a side view of a wireless communication device according to another exemplary embodiment.

FIG. 7 is a schematic view of a wireless communication device according to a further exemplary embodiment.

### DETAILED DESCRIPTION OF THE EMBODIMENTS

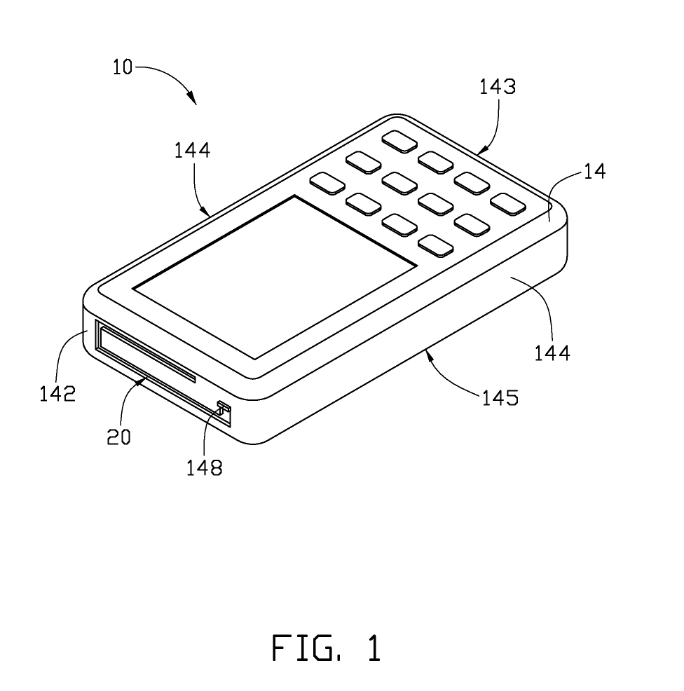

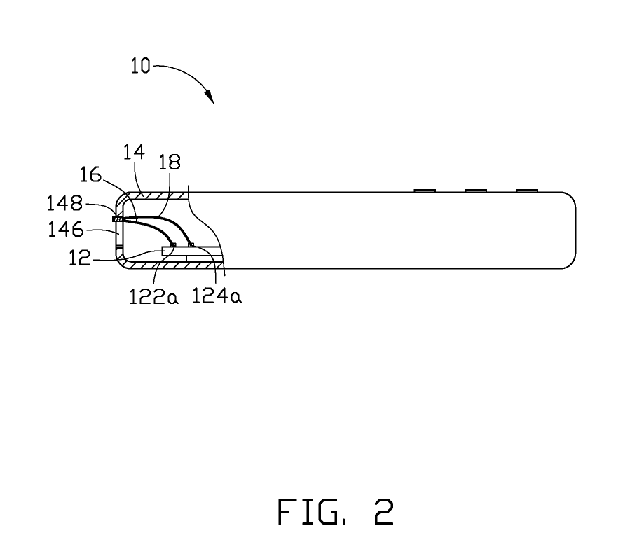

Referring to FIGS. 1 and 2, a wireless communication device 10 according to an exemplary embodiment includes a metallic housing 14, a circuit board 12 received in the metallic housing 14 and an antenna 20. The wireless communication device may be a cell phone, a personal digital assistant device, a personal computer, or a laptop. In this exemplary embodiment, the wireless communication device 10 is a cell phone.

The circuit board 12 includes a feeding portion 122a and a grounding portion 124a.

The metallic housing 14 includes a top sheet 142, two side sheets 144 perpendicularly connected to the top sheet 142 respectively, a bottom sheet 143 is opposite to the top sheet 142, and a rear sheet 145 connected to the top sheet 142, the side sheets 144 and the bottom sheet 143.

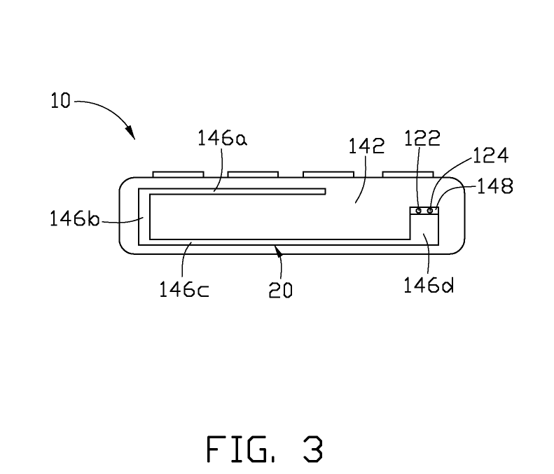

Referring to FIG. 3, the antenna 20 includes the top sheet 142. The top sheet 142 defines a first slot 146a, a second slot 146b, a third slot 146c, and a fourth slot 146d. The second slot 146b perpendicularly connects to the first slot 146a and the third slot 146c and has a length greater than that of the fourth slot 146d. The third slot 146c has a length greater than that of the first slot 146a. The fourth slot 146d extends perpendicularly from an end of the third slot 146c away from the second slot 146b. The extending direction of the second slot 146b from the third slot 146c is the same as that of the fourth slot 146d from the third slot 146c. The extending direction of the first slot 146a from the second slot 146b is the same as that of the third slot 146c from the second slot 146b. In this way, the first slot 146a is adequately spaced from the fourth slot 146d. The slots 146a, 146b, 146c and 146d may be formed via punching or etching.

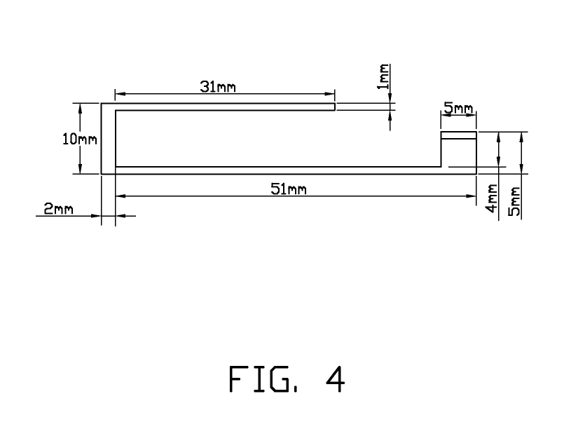

Referring to FIG. 4, the length of the first slot 146a is approximately 31 millimeters (mm) and the width is approximately 1 mm. The length of the second slot 146b is approximately 10 mm and the width is approximately 2 mm. The length of the third slot 146c is approximately 51 mm and the width is approximately 1 mm. The length of the fourth slot 146d is approximately 5 mm and the width is approximately 4 mm.

Referring to FIG. 2 and FIG. 3 together with FIG. 4, a conductive portion 148 is received on an end of the fourth slot 146d away from the third slot 146c, and includes a feeding point 122 and a grounding point 124 formed thereon. The feeding portion 122a and the grounding portion 124a are electrically connected to the feeding point 122 and the grounding point 124 of the antenna 20 by two wires 16, 18, respectively.

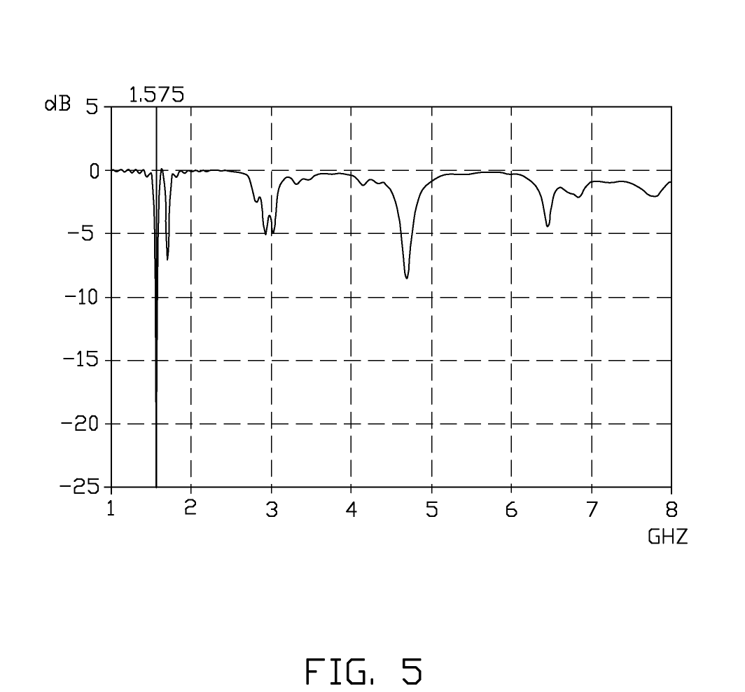

Referring to FIG. 5, the return loss versus frequency characteristic of the antenna 20 is shown. The antenna 20 achieves a return loss about −25 dB at approximate 1.575 GHz for receiving or radiating GPS signals.

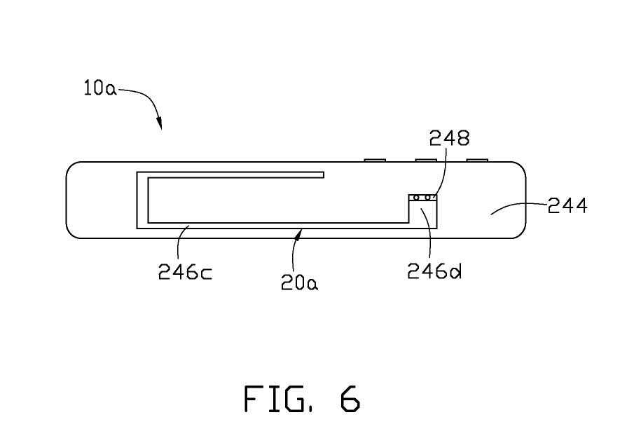

Referring to FIG. 6, a wireless communication device 10a according to another embodiment is shown. The difference between the wireless communication device 10 of the first embodiment and the wireless communication device 10a of this embodiment, is that the antenna 20a includes the side sheet 244. The side sheet 244 defines the slots. The conductive portion 248 is received at an end of the fourth slot 246d away from the third slot 246c. The slots of the antenna may be defined on one of the other side sheet, the bottom sheet or the rear sheet.

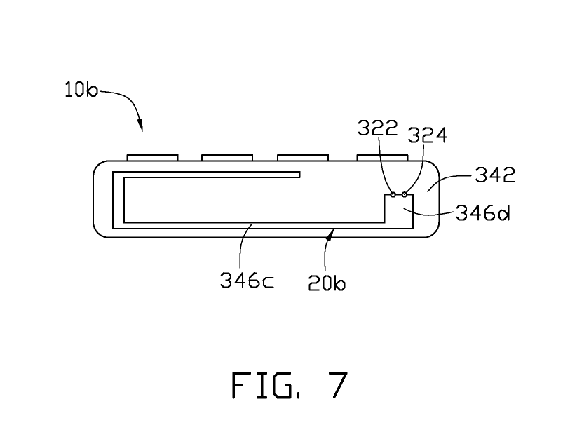

Referring to FIG. 7, a wireless communication device 10b according to a further embodiment is shown. The difference between the wireless communication device 10 and the wireless communication device 10b is that no conductive portion is on the end of the fourth slot 346d but the feeding point 322 of the antenna 20b is formed on the top sheet 342 at a distal side of the fourth slot 346d away from the third slot 346c, and a grounding point 324 is formed on the top sheet 342 at the distal side of the fourth slot 346d at a position different from that of the feeding point 322.

In summary, the wireless communication device is able to use a metallic housing while maintaining normal operation of the antenna.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1 An antenna comprising:
a metallic sheet defining a first slot, a second slot, a third slot parallel to the first slot, and a fourth slot parallel to the second slot, the second slot perpendicularly connecting the first slot to the third slot and having a length greater than that of the fourth slot; the third slot having a length greater than the length of the first slot, the fourth slot extending perpendicularly from a side of the third slot away from the second slot with the extending direction same as the extending direction of the second slot from the third slot, the extending direction of the first slot from the second slot being the same as the extending direction of the third slot from the second slot;
a feeding point formed on the metallic sheet at a side of the fourth slot away from the third slot; and
a grounding point formed on the metallic sheet at a side of the fourth slot away from the third slot at a position different from the position of the feeding point.

2. The antenna as claimed in claim 1, wherein the slots are formed in the metallic sheet via punching.

3. The antenna as claimed in claim 1, wherein the slots are formed in the metallic sheet via etching.

4. The antenna as claimed in claim 1, wherein the length of the first slot is approximately 31 mm and the width is approximately 1 mm; the length of the second slot is approximately 10 mm and the width is approximately 2 mm; the length of the third slot is approximately 51 mm and the width is approximately 1 mm; the length of the fourth slot is approximately 5 mm and the width is approximately 4 mm.

5. A wireless communication device comprising:
a housing including a metallic sheet, the metallic sheet defining a first slot, a second slot, a third slot parallel to the first slot and a fourth slot parallel to the second slot, the second slot perpendicularly connecting the first slot to the third slot and having a length greater than the length of the fourth slot; the third slot having a length greater than the length of the first slot, the fourth slot extending perpendicularly from a side of the third slot away from the second slot with the same extending direction as the extending direction of the second slot from the third slot, the extending direction of the first slot from the second slot being the same as the extending direction of the third slot from the second slot; and
a conductive portion received at a side of the fourth slot away from the third slot, comprising a feeding point, and a grounding point at a position different from the position of the feeding point.

6. The wireless communication device as claimed in claim 5, wherein the slots are formed on the metallic sheet via punching.

7. The wireless communication device as claimed in claim 5, wherein the slots are formed on the metallic sheet via etching.

8. The wireless communication device as claimed in claim 5, wherein the length of the first slot is approximately 31 mm and the width is approximately 1 mm; the length of the second slot is approximately 10 mm and the width is approximately 2 mm; the length of the third slot is approximately 51 mm and the width is approximately 1 mm; the length of the fourth slot is approximately 5 mm and the width is approximately 4 mm.

9. The wireless communication device as claimed in claim 5, wherein the wireless communication device is a cell phone.

10. The wireless communication device as claimed in claim 5, wherein the wireless communication device is a personal digital assistant device.

11. The wireless communication device as claimed in claim 5, wherein the wireless communication device is a personal computer.

12. The wireless communication device as claimed in claim 5, wherein the wireless communication device is a laptop.

13. An antenna comprising:
a metallic sheet defining a slotted structure, the slotted structure comprising a first slot, a second slot, a third slot and a fourth slot, the first slot and the third slot perpendicularly extending from two sides of the second slot respectively along a same direction, the second slot and the fourth slot perpendicularly extending from two sides of the third slot respectively along a same direction, the length of the second slot being greater than the length of the fourth slot and the length of the third slot being greater than the length of the first slot;
a feeding point formed on the metallic sheet at a distal side of the fourth slot away from the third slot; and
a grounding point formed on the metallic sheet at a distal side of the fourth slot at a position different from the position of the feeding point.

14. The antenna as claimed in claim 13, wherein the length of the first slot is approximately 31 mm and the width thereof is approximately 1 mm; the length of the second slot is approximately 10 mm and the width thereof is approximately 2 mm; the length of the third slot is approximately 51 mm and the width thereof is approximately 1 mm; the length of the fourth slot is approximately 5 mm and the width is approximately 4 mm.

15. The antenna as claimed in claim 13, wherein the slotted structure is formed on the metallic sheet via punching.

16. The antenna as claimed in claim 13, wherein the slotted structure is formed on the metallic sheet via etching.
